(19) United States
(12) Patent Application Publication
(10) Pub. No.: US 2025/0385562 A1
(43) Pub. Date: Dec. 18, 2025

(54) STATOR

(71) Applicant: DENSO CORPORATION, Kariya-city (JP)

(72) Inventor: Hiroshi Imai, Kariya-city (JP)

(73) Assignee: DENSO CORPORATION, Kariya-city (JP)

(21) Appl. No.: 19/316,482

(22) Filed: Sep. 2, 2025

Related U.S. Application Data
(63) Continuation of application No. PCT/JP2023/046774, filed on Dec. 26, 2023.

(30) Foreign Application Priority Data
Mar. 2, 2023 (JP) 2023-032110

(51) Int. Cl. H02K 3/52

(52) U.S. Cl. CPC H02K 3/522; H02K 2203/06

(57) ABSTRACT

A crossover wire is led out from a winding portion in a direction in which the winding portion is tightened. The crossover wire connected to a winding-end portion is crossed at a connecting portion between an insulating section and a linking portion such that it is located on one axial side of the linking portion with respect to the crossover wire connected toa winding-start portion. The crossover wire connected to the winding-end portion is held by a guiding portion so as to pass through the other axial side of the linking portion so that the position of a held portion held by a guiding portion is lowered to the position of the crossover wire connected to the winding-start portion.

### CROSS-REFERENCE TO RELATED APPLICATION

This application is the U.S. bypass application of International Application No. PCT/JP2023/046774 filed on Dec. 26, 2023 which designated the U.S. and claims priority to Japanese Patent Application No. 2023-032110 filed on Mar. 2, 2023, the contents of both of which are incorporated herein by reference.

### TECHNICAL FIELD

The present disclosure relates to a stator.

### BACKGROUND

JP 5502115 B discloses a so-called split core type stator. The split core type stator is composed of a plurality of stator components. The plurality of stator components are integrated by attaching an upper stator component to a lower stator component from the stator axis direction.

### SUMMARY

One aspect of the present disclosure is a stator including a plurality of core components that form an annular yoke, each having a yoke component divided in the circumferential direction of the yoke, and a tooth portion protruding from each of the yoke component toward the inside in the radial direction of the yoke; a plurality of windings having winding portions wound around each of the tooth portions and crossover wires connecting the winding portions to each other; and a plurality of insulators disposed in each of the core components, including an insulating portion that insulates the tooth portion from the winding portion, and a linking portion that connects inner radial ends of the insulating portions to each other; wherein the crossover wire is led out from the winding portion in a direction in which the winding portion is tightened; the crossover wire connected to a winding-start portion of a winding section that is located in the middle of the winding order among the plurality of winding sections and the crossover wire connected to a winding-end portion cross each other at a connecting portion between the insulating section and the linking portion such that the crossover wire connected to the winding-end portion is located on one axial side of the linking portion with respect to the crossover wire connected to the winding-start portion; the linking portion has a guiding portion that extends radially outward from the position between the adjacent insulating portions; and the crossover wire connected to the winding-end portion is held by the guiding portion so as to pass through the other axial side of the linking portion relative to the guiding portion so that the position of a held portion of the crossing wire connected to the winding-end portion of the winding that is held by the guiding portion is lowered toward the axial opposite side of the linking portion to the position of the crossover wire connected to the winding-start portion.

### BRIEF DESCRIPTION OF THE DRAWINGS

The above features of the present disclosure will be made clearer by the following detailed description, given referring to the appended drawings. In the accompanying drawings:

FIG. 1 shows a perspective view of a stator according to an embodiment of the present disclosure;

FIG. 2 shows a perspective view of two stator components in an assembled state according to the embodiment of the present disclosure;

FIG. 3 shows an enlarged view of a part of FIG. 2;

FIG. 4 shows a perspective view of a stator component according to the embodiment of the present disclosure;

FIG. 5 shows an enlarged view of a part of FIG. 4;

FIG. 6 shows a plan view of the stator component according to the embodiment of the present disclosure;

FIG. 7 shows an enlarged view of a part of FIG. 6; and

FIG. 8 shows a plan view of an example of a stator component.

### DETAILED DESCRIPTION OF THE PREFERRED EMBODIMENTS

As a result of detailed investigation by the inventors, it was found that in so-called split core type stators, there is a need for a stator that can have a short axial length even if crossover wires cross each other.

The present disclosure provides a stator that can shorten its axial length even when crossover wires are crossed.

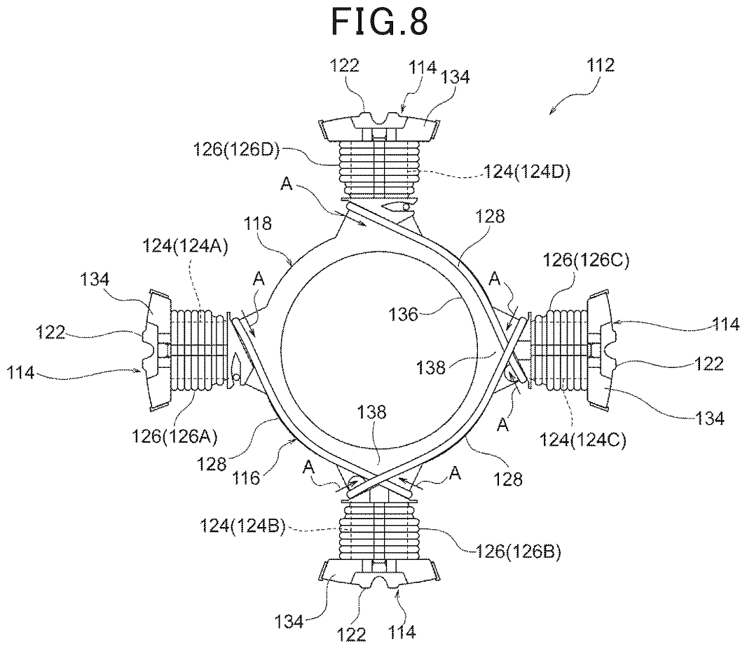

FIG. 8 is a plan view showing an example of a stator component 112. Each stator component 112 includes a plurality of core components 114, windings 116, and insulators 118. Each core component 114 forms an annular yoke and includes a yoke component 122 divided in the circumferential direction of the yoke, and tooth portions 124 protruding from the yoke component 122 radially inward of the yoke. The windings 116 include winding portions 126 wound around each tooth portion 124 and crossover wires 128 connecting the winding portions 126 to each other. The insulators 118 are disposed in each core component 114 and each has an insulating portion 134 that insulates the tooth portion 124 and the winding portion 126, and a linking portion 136 that connects inner radial ends of the insulating portions 134.

The windings 116 are wound around the plurality of tooth portions 124 in sequence along the circumferential direction of the stator components 112. That is, the windings 116 are wound in the order of a tooth portion 124A, a tooth portion 124B, a tooth portion 124C, and a tooth portion 124D. As a result, a winding portion 126A, a winding portion 126B, a winding portion 126C, and a winding portion 126D are formed. Each crossover wire 128 is led out from the winding portion 126 in the direction in which the winding portion 126 is tightened (direction of arrow A). Among winding portions 126A to 126D, the winding portion 126B, which is located in the middle (second) of the winding order, has crossover wires 128 connected to both a winding-start portion and a winding-end portion of the winding portion 126B. The crossover wire 128 connected to the winding-start portion and the crossover wire 128 connected to the winding-end portion intersect at a connecting portion 138 between the insulating portion 134 and the linking portion 136 corresponding to the winding portion 126B. Similarly, the crossover wires 128 are connected to the winding-start portion and the winding-end portion of the winding portion 126C, which is located in the middle (third) of the winding portions 126A to 126D. The crossover wire 128 connected to the winding-start portion and the crossover wire 128 connected to the winding-end portion intersect at a connecting portion 138 between the insulating portion 134 and the linking portion 136 corresponding to the winding portion 126C.

However, when each crossover wire 128 is led out from the winding portion 126 in the direction in which the winding portion 126 is tightened, the crossover wire 128 connected to the winding-start portion of the winding portion 126 located in the middle of the winding order among the plurality of winding portions 126 and the crossover wire 128 connected to the winding-end portion of the winding portion 126 cross at the connecting portion 138 between the insulating portion 134 and the linking portion 136. If the crossover wires 128 cross in this way, when the upper stator component 112 is assembled to the lower stator component 112 from one axial side of the stator, there is a risk that the crossover wire 128 wired to the lower stator component 112 and connected to the winding-end portion may interfere with the connecting portion 138 disposed on the upper stator component 112 if it is, for example, bent or slack.

Here, in order to avoid interference between the crossover wire 128, which is wired to the lower stator component 112 and connected to the winding-end portion, and the connecting portion 138 disposed on the upper stator component 112, it is possible to position the connecting portion 138 away from the crossover wire 128 in the axial direction of the stator; however, doing so would increase the axial length of the stator.

The purpose of the present embodiment is to provide a stator that can be made shorter in the axial direction even when the cross wires intersect.

A first aspect of the present embodiment is a stator including a plurality of core components that form an annular yoke, each having a yoke component divided in the circumferential direction of the yoke, and a tooth portion protruding from each of the yoke component toward the inside in the radial direction of the yoke; a plurality of windings having winding portions wound around each of the tooth portions and crossover wires connecting the winding portions to each other; and a plurality of insulators disposed in each of the core components, including an insulating portion that insulates the tooth portion from the winding portion, and a linking portion that connects inner radial ends of the insulating portions to each other; wherein the crossover wire is led out from the winding portion in a direction in which the winding portion is tightened; the crossover wire connected to a winding-start portion of a winding section that is located in the middle of the winding order among the plurality of winding sections and the crossover wire connected to a winding-end portion cross each other at a connecting portion between the insulating section and the linking portion such that the crossover wire connected to the winding-end portion is located on one axial side of the linking portion with respect to the crossover wire connected to the winding-start portion; the linking portion has a guiding portion that extends radially outward from the position between the adjacent insulating portions; and the crossover wire connected to the winding-end portion is held by the guiding portion so as to pass through the other axial side of the linking portion relative to the guiding portion so that the position of a held portion of the crossing wire connected to the winding-end portion of the winding that is held by the guiding portion is lowered toward the axial opposite side of the linking portion to the position of the crossover wire connected to the winding-start portion.

In the first aspect of the present embodiment, the linking portion has a guiding portion extending radially outward from the position between adjacent insulating portions. Then, the crossover wire connected to the winding-end portion is held by the guiding portion so as to pass through the other axial side of the linking portion relative to the guiding portion, so that the position of the portion of the crossover wire connected to the winding-end portion that is held by the guiding portion is lowered toward the other axial side of the linking portion to the position of the crossover wire connected to the winding-start portion. Therefore, it is possible to avoid interference between the crossover wire connected to the winding-end portion at the lower stator component and the linking portion disposed in the upper stator component.

Further, since it is not necessary to dispose the linking portion apart from the crossover wires in the axial direction of the stator, it is possible to shorten the axial length of the stator even if the crossover wires intersect.

A second aspect of the present embodiment is that, in the first aspect of the present embodiment, the stator is composed of a plurality of stator components (12); the plurality of stator components include a lower stator component and an upper stator component attached to the lower stator component from one axial side of the stator; and a connecting portion between the insulating portion and the linking portion disposed in the upper stator component is located on one axial side of the stator with respect to the crossover wire that is wired to the lower stator component and connected to the winding-start portion.

In the second aspect of the present embodiment, the connecting portion between the insulating portion disposed in the upper stator component and the linking portion is located on one axial side of the stator with respect to the crossover wire wired to the lower stator component and connected to the winding-start portion. Therefore, between the crossover wire connected to the winding-start portion, which is wired to the lower stator component, and the crossover wire connected to the winding-end portion, which is wired to the upper stator component, the connecting portion between the insulating portion and the linking portion disposed in the upper stator component is disposed. This allows the crossover wire connected to the winding-start portion of the lower stator component and the crossover wire connected to the winding-end portion of the upper stator component to be separated in the axial direction of the stator, thereby ensuring insulation between the crossover wires.

A third aspect of the present embodiment is that, in the first aspect or the second aspect of the present embodiment, the guiding portion is formed in a wall-like shape extending in the circumferential direction of the linking portion.

In the third aspect of the present embodiment, the guiding portion is formed in a wall-like shape extending in the circumferential direction of the linking portion. Therefore, for example, compared to cases where the guiding portion is formed in a pin shape, it is possible to ensure the rigidity of the guiding portion. This prevents the guiding portion from being deformed even when the crossover wire is held by the guiding portion. Further, since the guiding portion is formed in a wall-like shape, the guiding portion functions as a rib, thereby increasing the rigidity of the linking portion.

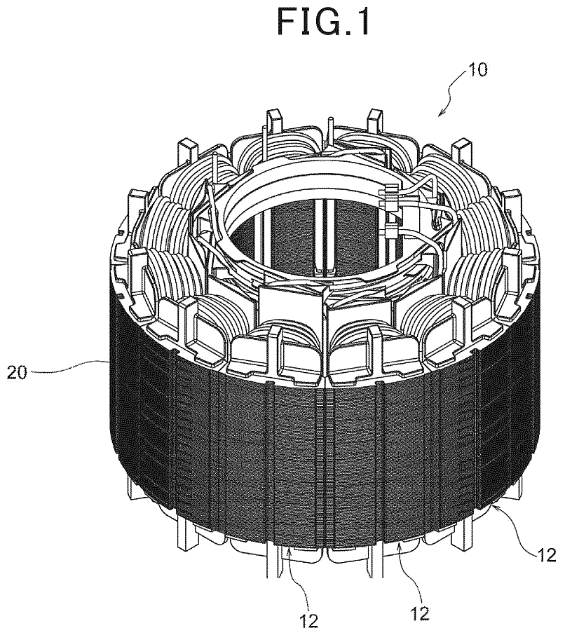

FIG. 1 is a perspective view of a stator 10 according to the present embodiment. The stator 10 is what is known as a split core type stator. The basic configuration of the split core type stator is disclosed in JP 5502115 B. The stator 10 is applied to an inner rotor type brushless motor. That is, a rotor (not shown in the figure) is rotatably accommodated inside the stator 10, and the brushless motor is constituted by the stator 10 and the rotor.

The stator 10 is composed of a plurality of stator components 12. The stator 10 has a U-phase, a V-phase, and a W-phase, and the number of the plurality of stator components 12 corresponds to the number of the U-phases, the V-phases, and the W-phases. That is, the stator 10 includes a U-phase stator components 12, a V-phase stator components 12, and a W-phase stator components 12. The plurality of stator components 12 are integrated by being assembled with each other from the axial direction of the stator 10.

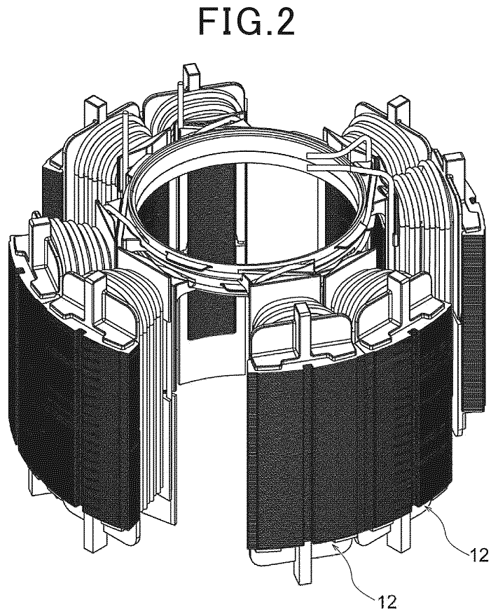

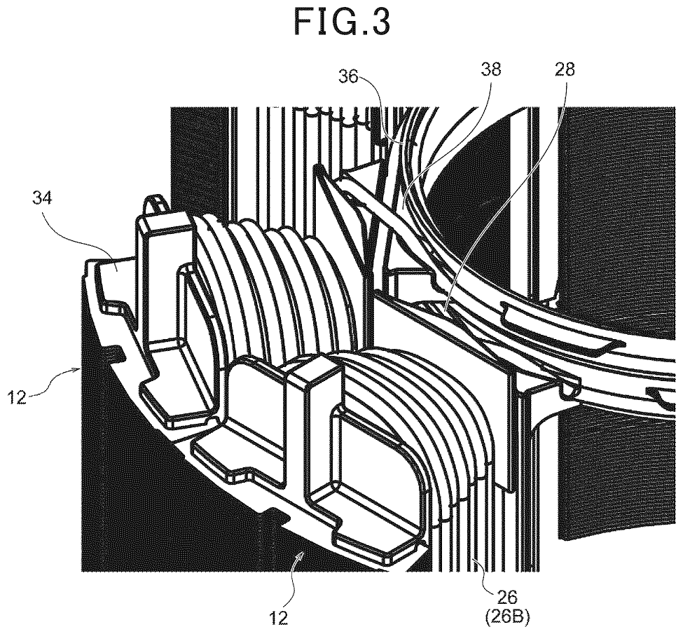

FIG. 2 is a perspective view showing the two stator components 12 in an assembled state in the present embodiment, and FIG. 3 is an enlarged view of a part of FIG. 2. Of the plurality of stator components 12, an upper stator component 12 is assembled to a lower stator component 12 from one axial side of the stator 10.

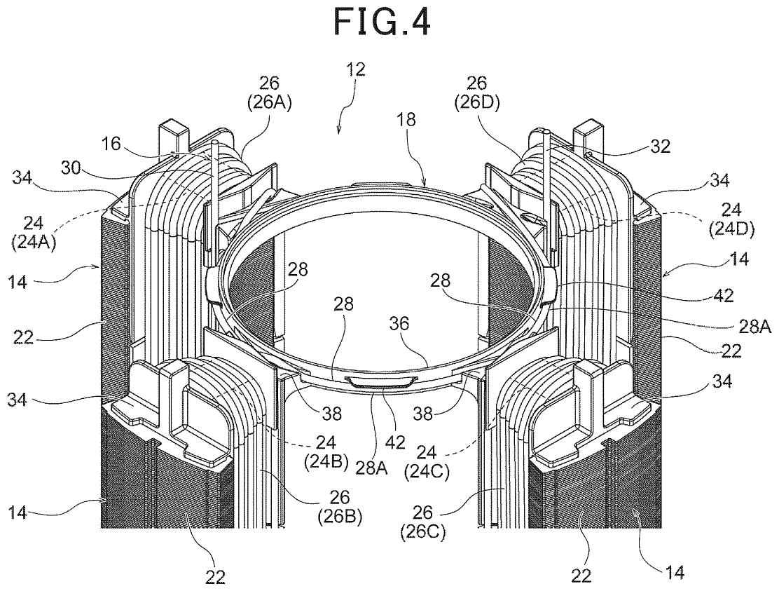

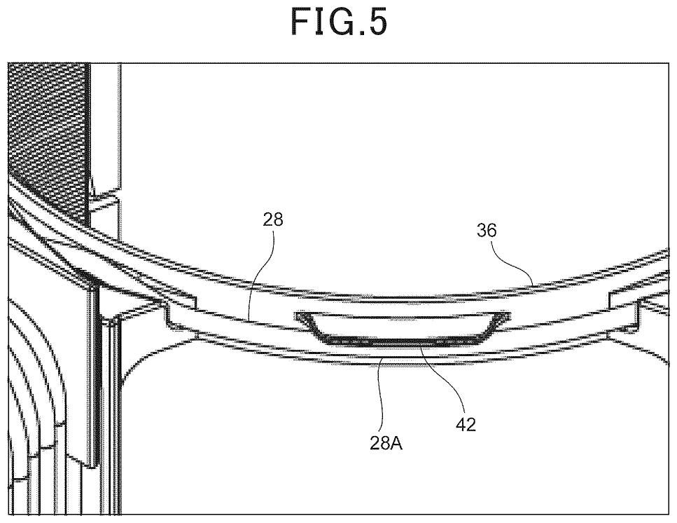

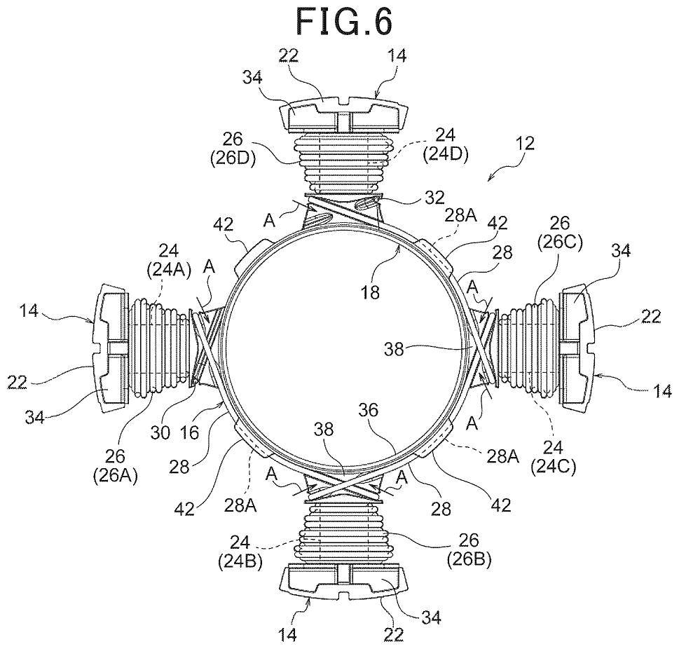

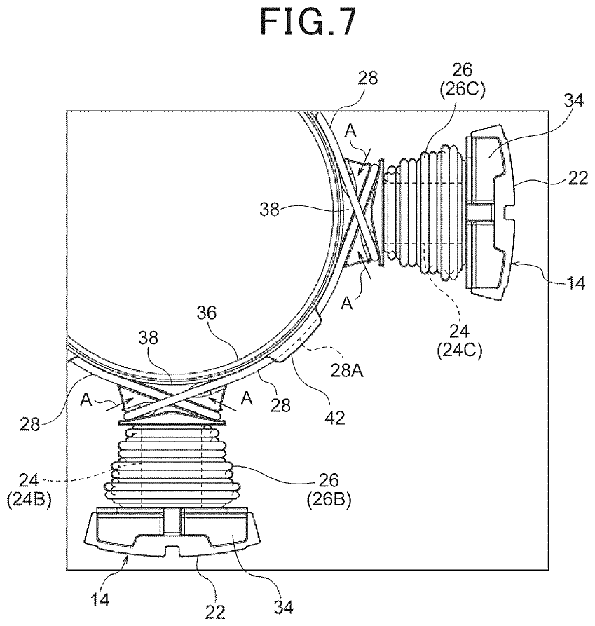

FIG. 4 is a perspective view of one stator component 12 according to the present embodiment, and FIG. 5 is an enlarged view of a part of FIG. 4. In addition, FIG. 6 is a plan view of one stator component 12 according to the present embodiment, and FIG. 7 is an enlarged view of a part of FIG. 6.

The stator component 12 includes a plurality of core components 14, windings 16, and insulators 18. Each core component 14 includes a ring-shaped yoke 20 (refer to FIG. 1) and has a yoke component 22 divided in the circumferential direction of the yoke 20 and a tooth portion 24 protruding from the yoke component 22 toward the inner side of the yoke 20 in the radial direction. The winding 16 includes a winding portion 26 wound around each tooth portion 24, a crossover wire 28 connecting the winding portions 26 to each other, a winding-start portion 30, and a winding-end portion 32. The insulator 18 is disposed in each core component 14 and has an insulating portion 34 that insulates the tooth portion 24 and the winding portion 26, and a linking portion 36 that connects inner radial ends of the insulating portions 34.

The windings 16 are wound sequentially around the circumference of stator component 12 on the plurality of tooth portions 24. That is, the windings 16 are wound in the order of a tooth portion 24A, a tooth portion 24B, a tooth portion 24C, and a tooth portion 24D. This forms a winding portion 26A, a winding portion 26B, a winding portion 26, and a winding portion 26D. Each crossover wire 28 is drawn out from the winding portion 26 in the direction in which the winding portion 26 is tightened (direction of arrow A).

The winding-start portion and the winding-end portion of the winding portion 26B, which is located in the middle (second) of the winding portions 26A to 26D, are connected to the crossover wires 28, respectively. The crossover wire 28 connected to the winding-start portion and the crossover wire 28 connected to the winding-end portion are drawn out in the tightening direction (direction of arrow A). As a result, the crossover wire 28 connected to the winding-end portion crosses over at a connecting portion 38 between the insulating portion 34 and the linking portion 36 corresponding to the winding portion 26B so that the crossover wire 28 connected to the winding-start portion is located on one axial side (upper side) of the linking portion 36 with respect to the crossover wire 28 connected to the winding-end portion.

Similarly, winding-start portion and the winding-end portion of the winding portion 26C, which is located in the middle (third) of the winding portions 26A to 26D, are connected to the crossover wires 28, respectively. The crossover wire 28 connected to the winding-start portion and the crossover wire 28 connected to the winding-end portion are drawn out in the tightening direction (direction of arrow A). As a result, the crossover wire 28 connected to the winding-end portion crosses over at a connecting portion 38 between the insulating portion 34 and the linking portion 36 corresponding to the winding portion 26C so that the crossover wire 28 connected to the winding-start portion is located on one axial side (upper side) of the linking portion 36 with respect to the crossover wire 28 connected to the winding-end portion.

As an example, the linking portion 36 is formed in the shape of an annular plate with the plate thickness direction being the radial direction of the linking portion 36. A plurality of guiding portions 42 are formed on the linking portion 36. The plurality of guiding portions 42 are formed at intervals in the circumferential direction of the linking portion 36. Each guiding portion 42 is formed on an outer peripheral surface of the linking portion 36. Each guiding portion 42 extends radially outward from the linking portion 36 from a position between adjacent insulating portions 34. Each guiding portion 42 is formed at a position on one axial side of the axial center of the linking portion 36, and extends in an arc shape along the circumferential direction of the linking portion 36. Each guiding portion 42 is located at the center between adjacent insulating portions 34.

Each crossover wire 28 is held by the guiding portion 42 so as to pass through the other axial side (lower side) of the linking portion 36 relative to the guiding portion 42. In addition, the crossover wire 28 connected to the winding-end portion of the winding portion 26B is held by the guiding portion 42 so as to pass through the other axial side (lower side) of the linking portion 36 relative to the guiding portion 42. As a result, the position of the held portion 28A, which is held by the guiding portion 42 of the crossover wire 28 connected to the winding-end portion of the winding portion 26B, is lowered toward the axial opposite side of the linking portion 36 to the position of the crossover wire 28 connected to the winding-start portion of the winding portion 26B. In other words, the held portion 28A held by the guiding portion 42 of the crossover wire 28 connected to the winding-end portion of the winding portion 26B, and the crossover wire 28 connected to the winding-start portion of the winding portion 26B are located at the same position (same height) in the axial direction of the linking portion 36.

Similarly, the crossover wire 28 connected to the winding-end portion of the winding portion 26C is held by the guiding portion 42 so as to pass through the other axial side (lower side) of the linking portion 36 relative to the guiding portion 42. As a result, the position of the held portion 28A, which is held by the guiding portion 42 of the crossover wire 28 connected to the winding-end portion of the winding portion 26C, is lowered toward the axial opposite side of the linking portion 36 to the position of the crossover wire 28 connected to the winding-start portion of the winding portion 26C. In other words, the held portion 28A held by the guiding portion 42 of the crossover wire 28 connected to the winding-end portion of the winding portion 26C, and the crossover wire 28 connected to the winding-start portion of the winding portion 26C are located at the same position (same height) in the axial direction of the linking portion 36.

In addition, the connecting portion 38 (refer to FIG. 3) between the insulating portion 34 and the linking portion 36 disposed in the upper stator component 12 is located on one side (the upper side) of the stator 10 in the axial direction with respect to the crossover wire 28, which is wired to the lower stator component 12 and connected to the winding-start portion of the winding portion 26B. Although not shown in the figure, the same applies to the crossover wire 28 connected to the winding-start portion of the winding portion 26C, which is wired to the lower stator component 12.

Next, the function and effects of the present embodiment will be explained.

In the stator 10 of the present embodiment, the linking portion 36 has the guiding portion 42 extending radially outward from the position between adjacent insulating portions 34. hen, the crossover wire 28 connected to the winding-end portion of the winding portion 26B is held by the guiding portion 42 so as to pass through the other axial side (lower side) of the linking portion 36 relative to the guiding portion 42. As a result, the position of the held portion 28A, which is held by the guiding portion 42 of the crossover wire 28 connected to the winding-end portion of the winding portion 26B, is lowered toward the axial opposite side of the linking portion 36 to the position of the crossover wire 28 connected to the winding-start portion of the winding portion 26B. Therefore, it is possible to avoid interference between the crossover wire 28, which is wired to the lower stator component 12 and connected to the winding-end portion of the winding portion 26B, and the linking portion 36 disposed in the upper stator component 12.

Similarly, the crossover wire 28 connected to the winding-end portion of the winding portion 26C is held by the guiding portion 42 so as to pass through the other axial side (lower side) of the linking portion 36 relative to the guiding portion 42. As a result, the position of the held portion 28A, which is held by the guiding portion 42 of the crossover wire 28 connected to the winding-end portion of the winding portion 26C, is lowered toward the other axial side of the linking portion 36 to the position of the crossover wire 28 connected to the winding-start portion of the winding portion 26C. Therefore, it is possible to avoid interference between the crossover wire 28, which is wired to the lower stator component 12 and connected to the winding-end portion of the winding portion 26C, and the linking portion 36 disposed in the upper stator component 12.

Further, since it is not necessary to dispose the linking portion 36 apart from the stator 10 in the axial direction with respect to the crossover wire 28, it is possible to shorten the axial length of the stator 10 even if the crossover wires 28 intersect.

Furthermore, in the stator 10 of the present embodiment, the connecting portion 38 (refer to FIG. 3) between the insulating portion 34 and the linking portion 36 disposed in the upper stator component 12 is located on one side (the upper side) of the stator 10 in the axial direction with respect to the crossover wire 28, which is wired to the lower stator component 12 and connected to the winding-start portion of the winding portion 26B. Although not shown in the figure, the same applies to the crossover wire 28 connected to the winding-start portion of the winding portion 26C, which is wired to the lower stator component 12. Therefore, between the crossover wire 28 connected to the winding-start portion connected to the lower stator component 12 and the crossover wire 28 connected to the winding-end portion connected to the upper stator component 12, the connecting portion 38 between the insulating portion 34 and the linking portion 36 disposed in the upper stator component 12 is disposed. This allows the crossover wire 28 connected to the winding-start portion of the lower stator component 12 and the crossover wire 28 connected to the winding-end portion of the upper stator component 12 to be separated in the axial direction of the stator 10, thereby ensuring insulation between the crossover wires 28.

In the stator 10 of the present embodiment, the guiding portion 42 is formed in a wall-like shape extending in the circumferential direction of the linking portion 36. Therefore, for example, compared to cases where the guiding portion 42 is formed in a pin shape, it is possible to ensure the rigidity of the guiding portion 42. This prevents the guiding portion 42 from being deformed even when the crossover wire 28 is held by the guiding portion 42. Further, since the guiding portion 42 is formed in a wall-like shape, the guiding portion 42 functions as a rib, thereby increasing the rigidity of the linking portion 36.

Note that although the guiding portion 42 is formed in a wall-like shape, it may also be formed in a shape other than a wall-like shape.

The present embodiment has been described above, but the present disclosure is not limited to the above, and it is understood that various modifications may be made without departing from the scope of the disclosure.

What is claimed is:

1. A stator comprising:
a plurality of core components that form an annular yoke, each having a yoke component divided in the circumferential direction of the yoke, and a tooth portion protruding from each of the yoke component toward the inside in the radial direction of the yoke;
a plurality of windings having winding portions wound around each of the tooth portions and crossover wires connecting the winding portions to each other; and
a plurality of insulators disposed in each of the core components, including an insulating portion that insulates the tooth portion from the winding portion, and a linking portion that connects inner radial ends of the insulating portions to each other; wherein
the crossover wire is led out from the winding portion in a direction in which the winding portion is tightened;
the crossover wire connected to a winding-start portion of a winding section that is located in the middle of the winding order among the plurality of winding sections and the crossover wire connected to a winding-end portion cross each other at a connecting portion between the insulating section and the linking portion such that the crossover wire connected to the winding-end portion is located on one axial side of the linking portion with respect to the crossover wire connected to the winding-start portion;
the linking portion has a guiding portion that extends radially outward from the position between the adjacent insulating portions; and
the crossover wire connected to the winding-end portion is held by the guiding portion so as to pass through the other axial side of the linking portion relative to the guiding portion so that the position of a held portion of the crossing wire connected to the winding-end portion of the winding that is held by the guiding portion is lowered toward the axial opposite side of the linking portion to the position of the crossover wire connected to the winding-start portion.

2. The stator according to claim 1, wherein
the stator is composed of a plurality of stator components
the plurality of stator components include a lower stator component and an upper stator component attached to the lower stator component from one axial side of the stator; and
a connecting portion between the insulating portion and the linking portion disposed in the upper stator component is located on one axial side of the stator with respect to the crossover wire that is wired to the lower stator component and connected to the winding-start portion.

3. The stator according to claim 1, wherein
the guiding portion is formed in a wall-like shape extending in the circumferential direction of the linking portion.

4. The stator according to claim 2, wherein
the guiding portion is formed in a wall-like shape extending in the circumferential direction of the linking portion.
